(19) United States
(12) Patent Application Publication
(10) Pub. No.: US 2002/0167510 A1
(43) Pub. Date: Nov. 14, 2002

(54) Display having memory in pixel part

(75) Inventor: Shoichiro Matsumoto, Ogaki-shi (JP)

Correspondence Address: McDERMOTT, WILL & EMERY, 600 13th Street, N.W., Washington, DC, 20005-3096, US

(73) Assignee: Sanyo Electric Co., Ltd.

(21) Appl. No.: 10/135,509

(22) Filed: May 1, 2002

(30) Foreign Application Priority Data
May 8, 2001 (JP) JP2001-137006

(51) Int. Cl. G09G 5/00

(52) U.S. Cl. 345/211

(57) ABSTRACT

A display capable of readily driving a memory provided on a pixel part with a power supply circuit in standby operation is obtained. This display comprises the pixel part having the memory and the power supply circuit formed on the same substrate as the pixel part for operating the memory. The power supply circuit at least includes a driver part for amplifying a clock signal and a pump part for performing charge pumping on the basis of the clock signal output from the driver part. Thus, the memory provided on the pixel part can be readily driven with the power supply circuit in the standby operation.

### BACKGROUND OF THE INVENTION

1. Field of the Invention

The present invention relates to a display, and more particularly, it relates to a display having a memory in a pixel part.

2. Description of the Background Art

Demand for a miniature liquid crystal display (LCD) employing a polysilicon TFT (thin film transistor) is recently increased. Therefore, reduction of power consumption in a display system including a liquid crystal panel and an external control IC is required. In particular, reduction in power consumption is strongly required to a liquid crystal display loaded on a portable telephone driven by a cell. In this case, power reduction is required to the liquid crystal display applied to the portable telephone not in a generally used state but on a wait screen in a wait state.

In order to reduce power consumption on the wait screen in the liquid crystal display loaded on the portable telephone, various techniques have been developed by employing a partial display system turning off a backlight or displaying necessary information only on part of the screen etc.

In order to reduce power consumption on the wait screen, there is proposed an LCD having a built-in memory as a system storing a memory such as an SRAM (static random access memory) in a pixel part while stopping driving by a peripheral circuit in a wait state thereby implementing low power consumption.

This LCD having a built-in memory includes three operation modes, i.e., an operation mode in general application, an operation mode for writing video data to be displayed in a wait state and an operation mode in a standby state. In the operation mode in general application, the LCD operates on the basis of basic clocks consisting of horizontal and vertical clocks. In other words, the LCD writes video data in pixels through a data line driving circuit and a scanning line driving circuit arranged around the pixels in the operation mode in general application.

In the operation mode for writing video data to be displayed in the wait state, the LCD writes the video data in the memory before entering the standby state. In the operation mode in the standby state, the LCD writes video data to be displayed in the standby state from the memory in liquid crystals.

In the aforementioned conventional LCD having a built-in memory, the basic clocks consisting of the horizontal and vertical clocks stop in the standby state, leading to absence of proper clocks driving a power supply circuit for operating the memory. In the conventional LCD having a built-in memory, therefore, it is difficult to drive the power supply circuit in the wait state and in the standby state, conceivably leading to difficulty in driving of the memory.

### SUMMARY OF THE INVENTION

An object of the present invention is to provide a display capable of readily driving a memory provided on a pixel part with a power supply circuit in standby operation.

Another object of the present invention is to attain low power consumption in a standby state in the aforementioned display.

In order to attain the aforementioned objects, a display according to a first aspect of the present invention comprises a pixel part having a memory and a power supply circuit formed on the same substrate as the pixel part for operating the memory. The power supply circuit at least includes a driver part for amplifying a clock signal and a pump part for performing charge pumping on the basis of the clock signal output from the driver part.

In the display according to the first aspect, the power supply circuit for operating the memory of the pixel part is provided on the same substrate as the pixel part while the power supply circuit at least includes the driver part and the pump part, whereby the memory provided on the pixel part can be readily driven with the power supply circuit in standby operation.

In the aforementioned display according to the first aspect, the power supply circuit preferably further includes a clock generation part for generating the clock signal. According to this structure, the clock generation part can individually generate a clock for driving the pump part also when a basic clock is stopped in a standby state, whereby the memory provided on the pixel part can be readily driven with the power supply circuit in the standby operation. In this case, the clock generation part may include a ring oscillator.

In the aforementioned display according to the first aspect, the power supply circuit preferably further includes an output value holding circuit for holding an output value from the pump part. According to this structure, the output value holding circuit can hold a power supply voltage stepped up by the pump part while stopping pumping. Thus, power consumption can be reduced when the output value holding circuit has small power consumption.

In the structure of the display including the aforementioned output value holding circuit, the output value holding circuit preferably starts operation in response to complete writing of still picture video data in the memory. According to this structure, the output value holding circuit having small power consumption can reduce power consumption after the still picture video data is completely written in the memory.

In the structure of the display including the aforementioned output value holding circuit, the power supply circuit further includes a first switch provided between the pump part and an output terminal of the power supply circuit to be turned off in response to complete writing of still picture video data in the memory and a second switch provided between the output value holding circuit and the output terminal of the power supply circuit to be turned on in response to the complete writing of the still picture video data in the memory. According to this structure, the output value holding circuit can readily hold the output value with the first and second switches after the still picture video data is completely written in the memory.

In the structure of the display including the aforementioned clock generation part, the power supply circuit preferably further includes an output value holding circuit for holding an output value from the pump part, and a current consumed by the output value holding circuit is preferably smaller than a current consumed by the clock generation part, the driver part and the pump part. According to this structure, power consumption can be readily reduced by holding the output value with the output value holding circuit after the still picture video data is completely written in the memory.

In the structure of the aforementioned display according to the first aspect, the power supply circuit consists of the driver part and the pump part, and a basic clock signal operating with the same power supply voltage as the pump part is input in the driver part. According to this structure, a desired power supply voltage can be reached through the basic clock signal. Thus, the power supply circuit may be provided with no clock generation circuit. In this case, the pump part preferably performs step-up operation by making a voltage reach a desired power supply voltage through the basic clock signal before entering a standby state.

In the structure of the display including the aforementioned clock generation part, the clock generation part preferably includes a voltage conversion circuit for converting a basic clock signal operating with a lower power supply voltage than the pump part to the same power supply voltage as the pump part. According to this structure, the basic clock signal can be readily employed as a pumping clock for operating the pump part. In this case, the pump part preferably performs step-up operation by making a voltage reach a desired power supply voltage through the basic clock signal and the voltage conversion circuit before entering a standby state.

In the structure of the display including the aforementioned clock generation part, the clock generation part preferably includes a clock generation circuit for generating the clock signal and a selection switch for selectively inputting the clock signal generated by the clock generation circuit and a basic clock signal in the driver part. According to this structure, the basic clock signal can be employed in general operation while employing the clock signal generated by the clock generation circuit in a standby state where the basic clock signal is unavailable. In this case, the clock generation part preferably includes a voltage conversion circuit for converting a basic clock signal operating with a lower power supply voltage than the pump part to the same power supply voltage as the pump part. According to this structure, the basic clock signal can be readily employed as a pumping clock for operating the pump part.

The aforementioned display according to the first aspect may include either a liquid crystal display or an organic EL display.

A display according to a second aspect of the present invention comprises a pixel part having a memory and a power supply circuit formed on the same substrate as the pixel part for operating the memory. The power supply circuit at least includes a negative power supply circuit.

In the display according to the second aspect, a leakage current can be reduced in an OFF state of a transistor forming the memory such as an SRAM, for example, by applying a negative potential generated by the negative power supply circuit to the gate electrode of the transistor as compared with a case of applying 0 V to the gate electrode, due to the aforementioned structure. Thus, the memory can be improved in data holding property.

In the structure of the aforementioned display according to the second aspect, the power supply circuit preferably includes both of the negative power supply circuit and a positive power supply circuit. According to this structure, the positive power supply circuit can operate the memory while the negative power supply circuit can improve data holding properties of the memory in a standby state.

In the structure of the aforementioned display according to the second aspect, the negative power supply circuit preferably at least includes a driver part for amplifying a clock signal and a pump part for performing charge pumping on the basis of the clock signal output from the driver part. According to this structure, the negative power supply circuit can readily generate a negative voltage. In this case, the power supply circuit preferably further includes a clock generation part for generating the clock signal. According to this structure, the clock generation part can individually generate a clock for driving the pump part also when a basic clock is stopped in a standby state, whereby the negative power supply circuit can readily improve data holding properties of the memory in standby operation.

The aforementioned display according to the second aspect may include either a liquid crystal display or an organic EL display.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the overall structure of a liquid crystal display according to a first embodiment of the present invention;

FIG. 2 is a block diagram showing the internal structure of a positive power supply circuit built into the liquid crystal display according to the first embodiment shown in FIG. 1;

FIG. 3 is a circuit diagram showing the details of the internal structure of the positive power supply circuit shown in FIG. 2;

FIG. 4 is a block diagram showing the internal structure of a positive power supply circuit built into a liquid crystal display according to a second embodiment of the present invention;

FIG. 5 is a block diagram showing the internal structure of a positive power supply circuit built into a liquid crystal display according to a third embodiment of the present invention;

FIG. 6 is a block diagram showing the internal structure of a positive power supply circuit built into a liquid crystal display according to a fourth embodiment of the present invention;

FIG. 7 is a block diagram showing the internal structure of a positive power supply circuit built into a liquid crystal display according to a fifth embodiment of the present invention;

FIG. 8 is a block diagram showing the internal structure of a positive power supply circuit built into a liquid crystal display according to a sixth embodiment of the present invention;

FIG. 9 is a block diagram showing the overall structure of a liquid crystal display according to a seventh embodiment of the present invention;

FIG. 10 is a circuit diagram showing the internal structure of a negative power supply circuit built into the liquid crystal display according to the seventh embodiment shown in FIG. 9; and

FIG. 11 is a block diagram showing the overall structure of a liquid crystal display according to an eighth embodiment of the present invention.

### DESCRIPTION OF THE PREFERRED EMBODIMENTS

Embodiments of the present invention are now described with reference to the drawings.

(First Embodiment)

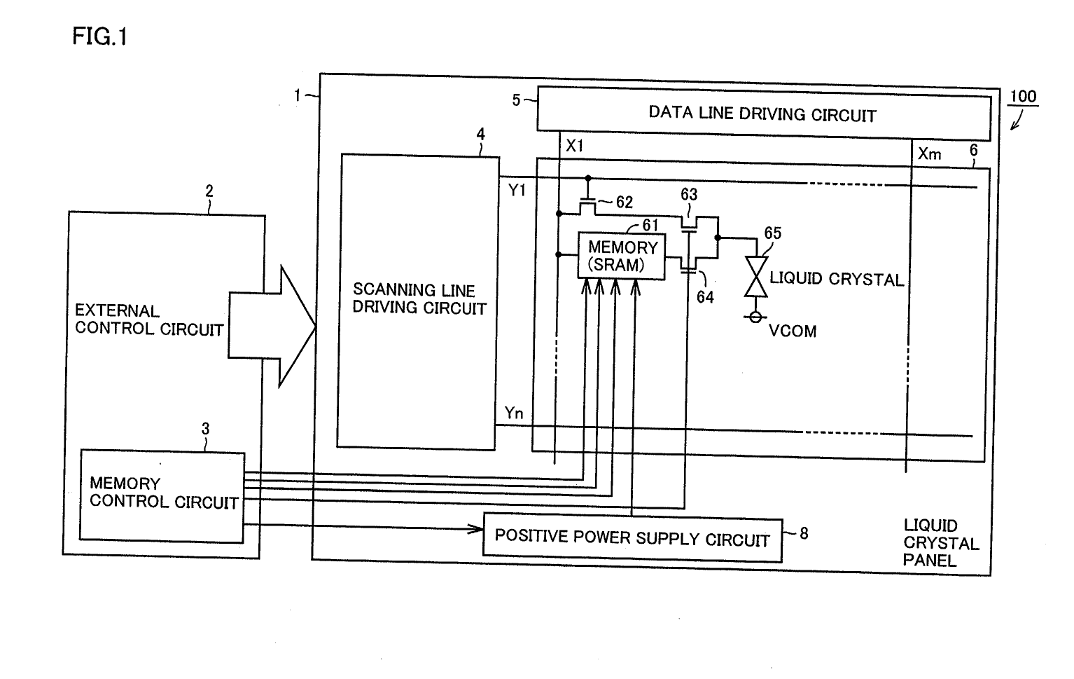

The overall structure of a liquid crystal display 100 according to a first embodiment of the present invention is now described with reference to FIG. 1. The liquid crystal display 100 according to the first embodiment comprises a liquid crystal panel 1 and an external control circuit 2. The liquid crystal panel 1 includes a scanning line driving circuit 4, a data line driving circuit 5, a pixel part (display part) 6 and a positive power supply circuit 8. In other words, the pixel part 6 and the positive power supply circuit 8 are formed on the same substrate (the same liquid crystal panel 1) in the first embodiment.

Each pixel forming the pixel part 6 includes a memory 61 consisting of an SRAM or the like, transistors 62, 63 and 64 and a liquid crystal 65. Such pixels are arranged in the form of a matrix in the pixel part 6. The memory 61 has a function of storing still picture video data to be displayed in a wait state while writing the data to be displayed in the wait state in the liquid crystal 65 through the transistor 64.

The external control circuit 2 includes a memory control circuit 3. The memory control circuit 3 controls the memory 61 as well as the positive power supply circuit 8.

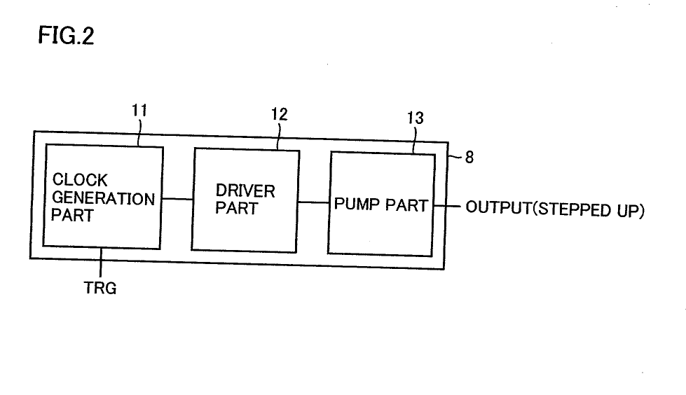

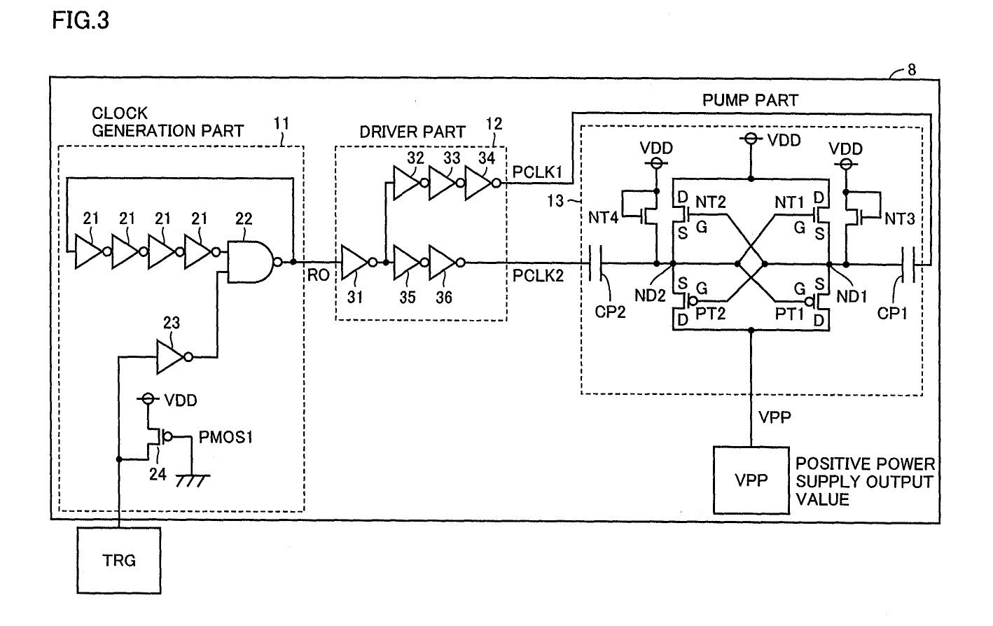

The structure of the positive power supply circuit 8 built into the liquid crystal panel 1 of the liquid crystal display 100 according to the first embodiment is now described with reference to FIGS. 2 and 3. The positive power supply circuit 8 includes a clock generation part 11, a driver part 12 and a pump part 13. A positive voltage stepped up by the positive power supply circuit 8 is used as the power source for the memory 61.

The clock generation part 11 has a function of receiving a start signal (trigger signal) TRG and starting generating a clock signal while transmitting a pulse signal to the driver part 12. The driver part 12 has a function of amplifying the clock signal transmitted from the clock generation part 11. The pump part 13 has a function of stepping up a potential to a desired potential VPP in response to the clock signal output from the driver part 12.

As shown in FIG. 3, the clock generation part 11 includes four inverter circuits 21, a NAND circuit 22, an inverter circuit 23 and a P-channel transistor 24.

In operation of the clock generation part 11, the P channel transistor 24 is normally ON and hence a high-level potential VDD is input in the inverter circuit 23. In this state, an input in the NAND circuit 22 from the inverter circuit 23 goes low and hence an output of the NAND circuit 22 is fixed in a high-level state. When the signal TRG (low) is received in this state, the input from the inverter circuit 23 to the NAND circuit 22 goes high and hence the output from the NAND circuit 22 goes low. Thus, a ring oscillator consisting of the inverter circuits 21 and the NAND circuit 22 sequentially generates clocks. The clock generation part 11 is operable also when supplied with power without receiving the signal TRG. In this case, the P-channel transistor 24, which is normally ON, and the inverter circuit 23 are unnecessary. The frequency of the ring oscillator consisting of the four inverter circuits 21 and the NAND circuit 22 is adjusted in response to the delay time of the inverter circuits 21.

In the liquid crystal display (LCD) 100 according to the first embodiment, the clock generation part 11 is provided on the positive power supply circuit 8 as hereinabove described, whereby the clock generation part 11 can individually generate clocks for driving the pump part 13 also when a basic clock is stopped in a standby state. Thus, the positive power supply circuit 8 can readily drive the memory 61 provided on the pixel part 6 in standby operation.

The driver part 12 includes inverter circuits 31, 32, 33, 34, 35 and 36. The driver part 12 amplifies the clock signal transmitted from the clock generation part 11 while generating clock signals PCLK1 and PCLK2 which are out of phase with each other.

The pump part 13 includes two capacitors CP1 ad CP2, two n-channel transistors NT1 and NT2 and two p-channel transistors PT1 and PT2. According to the first embodiment, the pump part 13 generates the prescribed stepped-up voltage VPP through nodes ND1 and ND2 connected to the capacitors CP1 and CP2 respectively.

The n-channel transistor NT1 has a drain terminal D connected to the power supply potential VDD and a source terminal S connected to the node ND1. The p-channel transistor PT1 has a source terminal S connected to the node ND1 and a drain terminal D connected to an output terminal. Gate terminals G of the n-channel transistor NT1 and the p-channel transistor PT1 are connected with each other in common and connected to the node ND2.

The n-channel transistor NT2 has a drain terminal D connected to the power supply potential VDD and a source terminal S connected to the node ND2. The p-channel transistor PT2 has a source terminal S connected to the node ND2 and a drain terminal D connected to the output terminal. Gate terminals G of the n-channel transistor NT2 and the p-channel transistor PT2 are connected with each other in common and connected to the node ND1.

The drain terminals D of the n-channel transistors NT1 and NT2 are connected with each other in common. The drain terminals D of the p-channel transistors PT1 and PT2 are also connected with each other in common. The clock signals PCLK1 and PCLK2 out of phase with each other are applied to terminals of the capacitors CP1 and CP2 not connected to the nodes ND1 and ND2 respectively.

The nodes ND1 and ND2 are provided with n-channel transistors NT3 and NT4 having drain terminals and gate terminals connected to the power supply potential VDD respectively.

The pump part 13 according to the first embodiment having the aforementioned structure pumps charges toward the potential VPP through either one of the p-channel transistors PT1 and PT2 every half cycle of the clock signals PCLK1 and PCLK2, thereby generating the stepped-up voltage VPP.

In the pump part 13 according to the first embodiment, the threshold voltages of the n-channel transistors NT1 and NT2 and the p-channel transistors PT1 and PT2 are not dropped, and hence the finally reached stepped-up voltage VPP exhibits a theoretical value 2VDD. Consequently, the reached stepped-up voltage is not influenced by dispersion in the characteristics of MOS transistors in the pump part 13 according to the first embodiment.

(Second Embodiment)

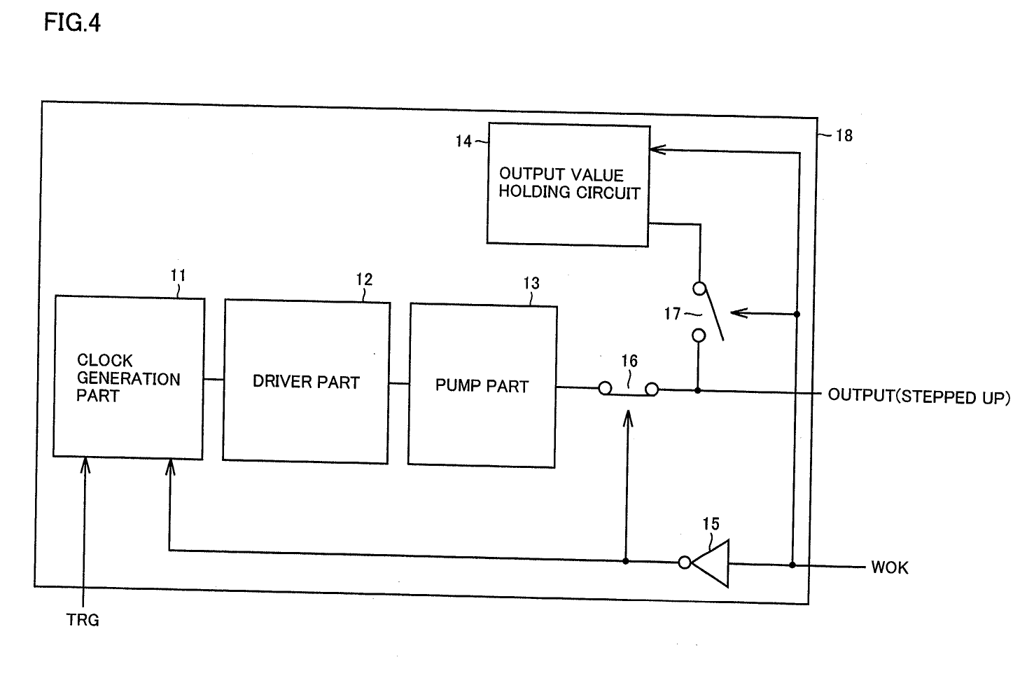

Referring to FIG. 4, an output value holding circuit 14 is added to a positive power supply circuit 18 in a liquid crystal display according to a second embodiment of the present invention.

More specifically, the positive power supply circuit 18 includes a clock generation part 11, a driver part 12, a pump part 13 and the output value holding circuit 14 in the second embodiment. Two switches 16 and 17 are provided between the output value holding circuit 14 and the pump part 13. The switch 16 is provided between an output terminal of the positive power supply circuit 18 and the pump part 13. The switch 17 is provided between the output terminal of the positive power supply circuit 18 and the output value holding circuit 14. The switch 16 is an example of the “first switch” according to the present invention, and the switch 17 is an example of the “second switch” according to the present invention.

A video data writing completion signal WOK (write OK) is input in the output value holding circuit 14 and the switch 17, and inverted by an inverter 15 to be input in the clock generation part 11 and the switch 16.

The second embodiment is so conditioned that a current consumed by the output value holding circuit 14 is necessarily smaller than a current consumed by the clock generation part 11, the driver part 12 and the pump 13.

In operation of the positive power supply circuit 18 according to the second embodiment, a start signal TRG indicating that the liquid crystal display enters a standby state is so received that the clock generation part 11 generates a clock and the driver part 12 amplifies the generated clock. The pump part 13 performs step-up operation with the clock. In this state, the switch 16 is ON and the switch 17 is OFF. Thus, still picture video data is written in a memory 61 (see FIG. 1) with the output voltage stepped up by the pump part 13. When the still picture video data is completely written in the memory 61, the video data writing completion signal WOK is activated. Therefore, the signal WOK is input in the output value holding circuit 14 and the switch 17 while a signal obtained by inverting the signal WOK is input in the clock generation part 11 and the switch 16. Thus, the clock generation part 11 stops generating the clock while the switch 16 is turned off and the switch 17 is turned on. Consequently, the output value holding circuit 14 holds the voltage stepped up by the pump part 13.

According to the second embodiment, as hereinabove described, the output value holding circuit 14 is so added to the positive power supply circuit 18 that power consumption can be reduced through the output value holding circuit 14 having small power consumption after the still picture video data is completely written in the memory 61.

When the start signal TRG is activated from power supply to a panel for starting pumping operation, the output value holding circuit 14 can also have a function of holding the voltage up to the standby state.

(Third Embodiment)

Referring to FIG. 5, a positive power supply circuit 28 is formed only by a driver part 12 and a pump part 13 in a liquid crystal display according to a third embodiment of the present invention. A horizontal clock CKH operating with the same power supply voltage as the pump part 13 is input in the driver part 12. The horizontal clock CKH is an example of the “basic clock signal” according to the present invention.

According to the third embodiment, a pump activation clock is formed not by the clock generated by the clock generation part 11 according to the first or second embodiment but by the horizontal clock CKH operating with the same power supply voltage as the pump part 13 as hereinabove described, whereby the positive power supply circuit 28 may be provided with no clock generation circuit. In this case, the horizontal clock CKH is stopped in a standby state, and hence the pump part 13 must step up a voltage to the desired power supply voltage with the horizontal clock CKH before entering the standby state.

(Fourth Embodiment)

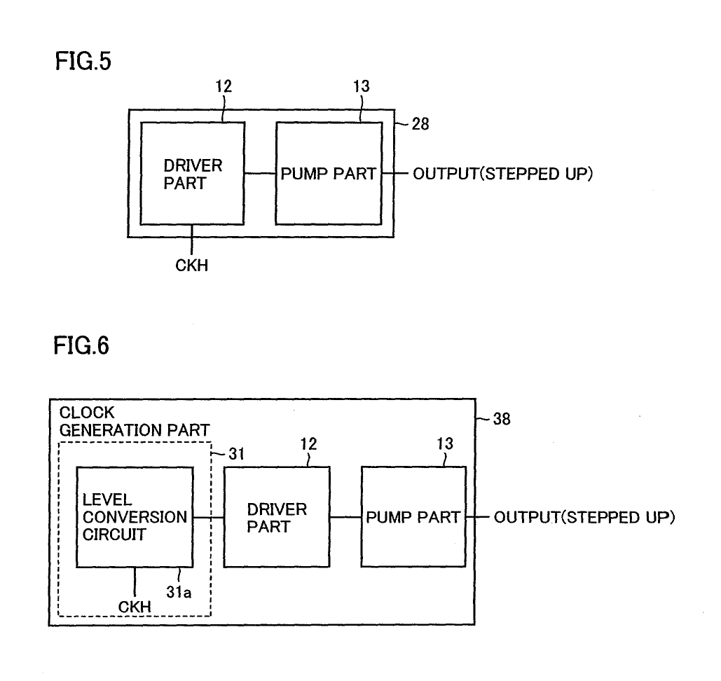

Referring to FIG. 6, a positive power supply circuit 38 includes a clock generation part 31, a driver part 12 and a pump part 13 in a liquid crystal display according to a fourth embodiment of the present invention. The clock generation part 31 includes a level conversion circuit 31a for converting a voltage of a horizontal clock CKH to the same power supply voltage as the pump part 13.

The liquid crystal display according to the fourth embodiment employs the horizontal clock CKH operating with a lower power supply voltage than the pump part 13.

Also in the fourth embodiment, the horizontal clock CKH is effective only in general application, and hence the desired power supply voltage must be reached through the horizontal clock CKH before entering a standby state.

(Fifth Embodiment)

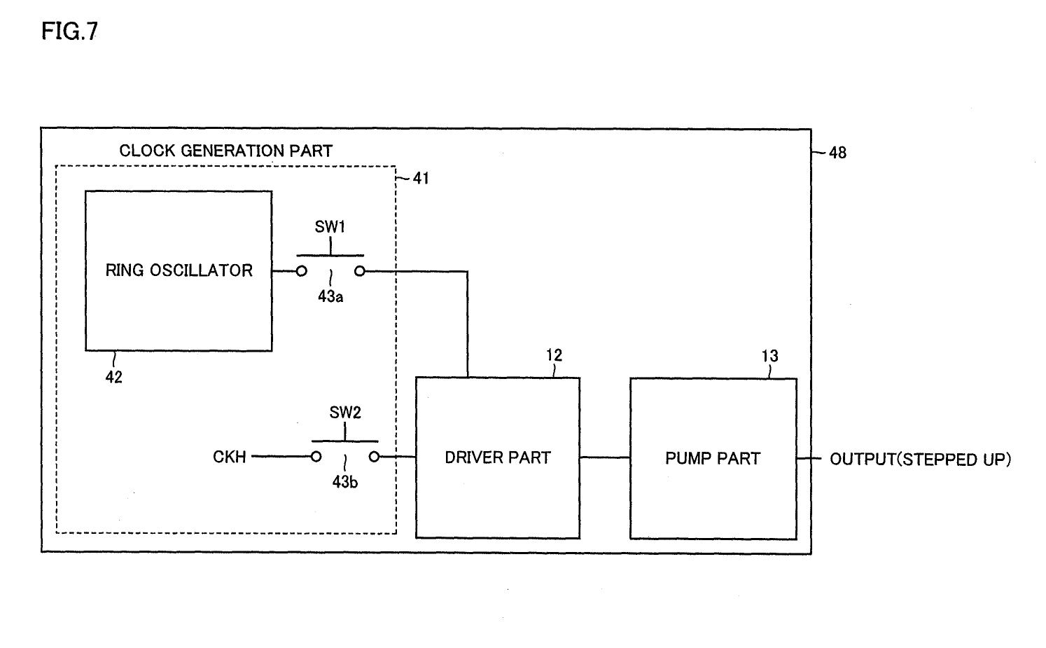

Referring to FIG. 7, a positive power supply circuit 48 includes a clock generation part 41, a driver part 12 and a pump part 13 in a liquid crystal display according to a fifth embodiment of the present invention. The clock generation part 41 includes a ring oscillator 42 for individually generating a clock and switches 43a and 43b. The ring oscillator 42 is an example of the “clock generation circuit” according to the present invention, and the switches 43a and 43b are examples of the “selection switch” according to the present invention.

The liquid crystal display according to the fifth embodiment switches a clock for driving the pump part 13 between a general operation state and a standby state. In the general operation state, the switch 43b is turned on and the switch 43a is turned off so that the pump part 13 performs pumping with a horizontal clock CKH. In the standby state, the switch 43a is turned on and the switch 43b is turned off while the ring oscillator 42 generates a clock, so that the pump part 13 performs pumping with the clock generated by the ring oscillator 42.

(Sixth Embodiment)

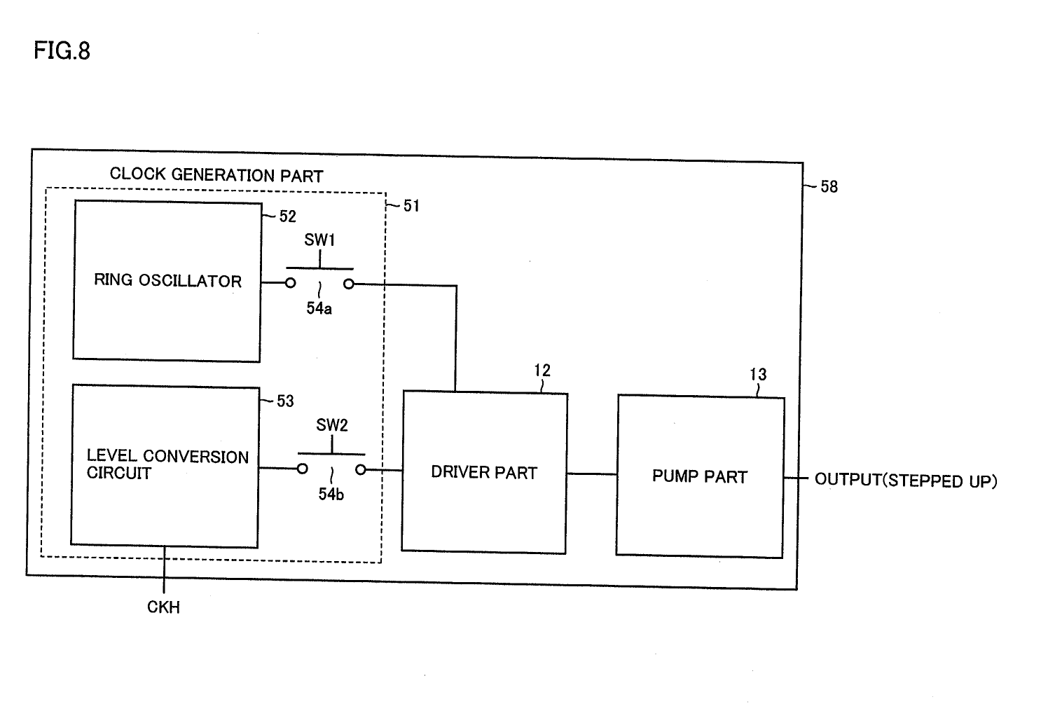

Referring to FIG. 8, a positive power supply circuit 58 includes a clock generation part 51, a driver part 12 and a pump part 13 in a liquid crystal display according to a sixth embodiment of the present invention. The clock generation part 51 includes a ring oscillator 52 for individually generating a clock, a level conversion circuit 53 for converting a voltage of a horizontal clock CKH to the same power supply voltage as the pump part 13 and switches 54a and 54b. When the horizontal clock CKH operates with a voltage smaller than the power supply voltage for driving the pump part 13 in a structure similar to that of the fifth embodiment shown in FIG. 7, the level conversion circuit 53 converts the horizontal clock CKH to the same voltage as that for driving the pump circuit 13 in the liquid crystal display according the sixth embodiment. The ring oscillator 52 is an example of the “clock generation circuit” according to the present invention, and the switches 54a and 54b are examples of the “selection switch” according to the present invention.

In general operation, the switch 54b is turned on and the switch 54a is turned off. The level conversion circuit 53 level-converts the horizontal clock CKH, and thereafter the pump part 13 performs step-up operation through the driver part 12. In a standby state, the switch 54a is turned on and the switch 54b is turned off. The pump part 13 performs step-up operation with the individual clock generated by the ring oscillator 52.

(Seventh Embodiment)

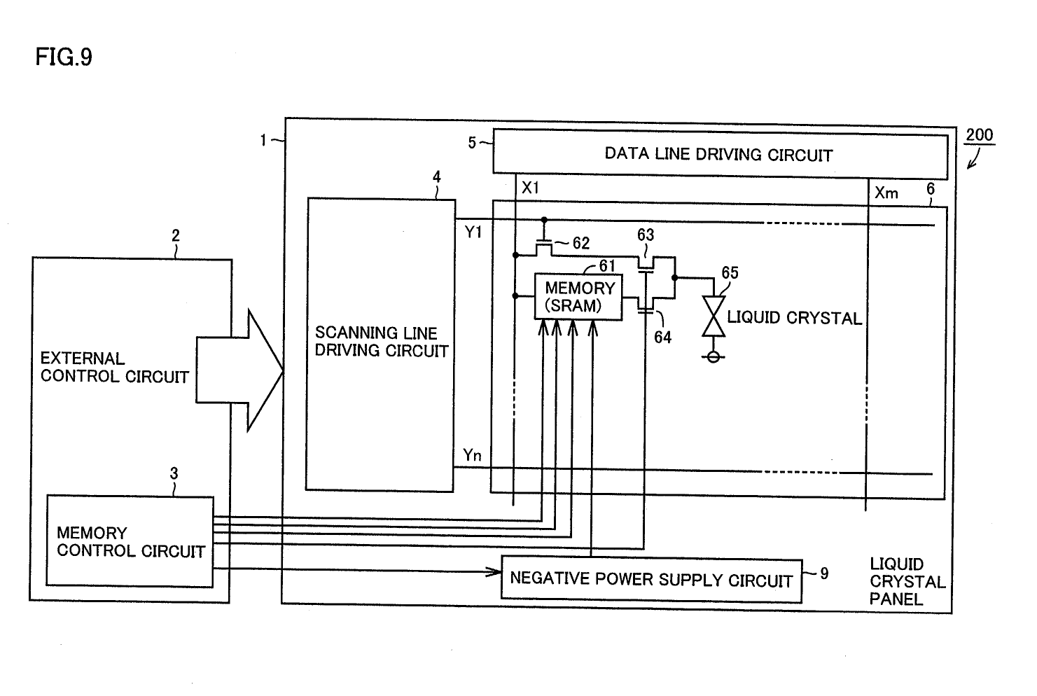

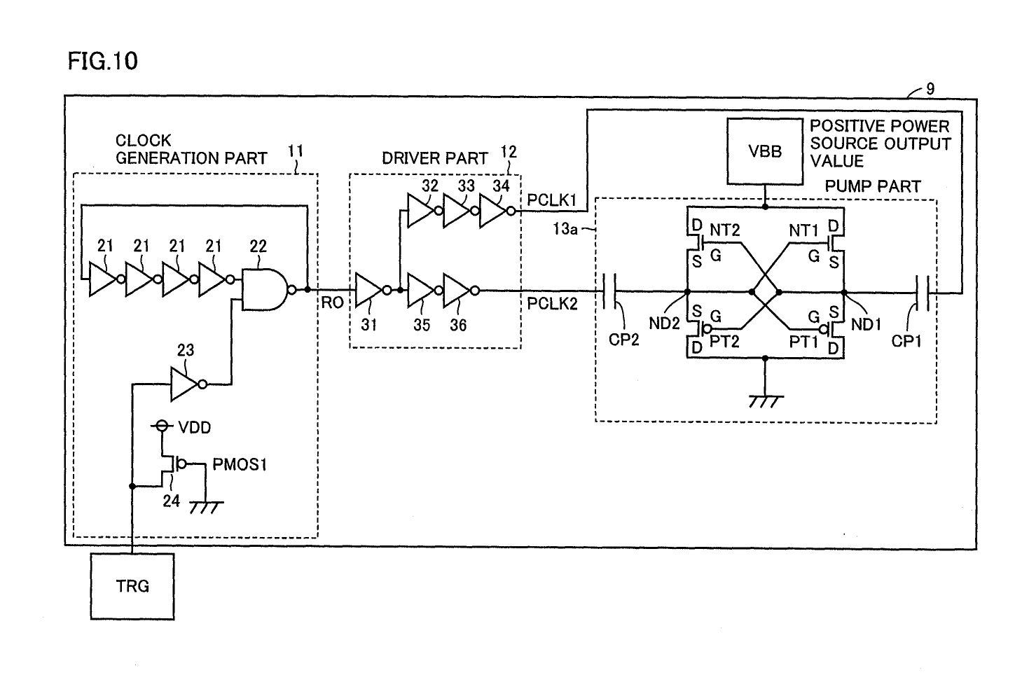

Referring to FIG. 9, a negative power supply circuit 9 is built into a liquid crystal panel 1 in a liquid crystal display 200 according to a seventh embodiment of the present invention, dissimilarly to the liquid crystal display 100 according to the first embodiment shown in FIG. 1. As shown in FIG. 10, the negative power supply circuit 9 includes a clock generation part 11, a driver part 12 and a pump part 13a. The clock generation part 11 and the driver part 12 are absolutely similar in structure to those of the positive power supply circuit 8 according to the first embodiment shown in FIG. 3.

However, the pump part 13a generates a negative power supply output value. More specifically, the pump part 13a according to the seventh embodiment includes two capacitors CP1 and CP2, two n-channel transistors NT1 and NT2 and two p-channel transistors PT1 and PT2. Connection states of these capacitors CP1 and CP2 and transistors NT1, NT2, PT1 and PT2 are similar to those in the pump part 13 according to the first embodiment shown in FIG. 3. The pump part 13a according to the seventh embodiment generates a prescribed negative power supply potential VBB through nodes ND1 and ND2 connected to the capacitors CP1 and CP2 respectively.

According to the seventh embodiment, the negative power supply circuit 9 is built into the liquid crystal panel 1 as hereinabove described, whereby the negative potential VBB generated by the negative power supply circuit 9 can be applied to a gate electrode of a transistor in a memory 61 (see FIG. 9) consisting of an SRAM. Thus, a leakage current can be reduced in an OFF state of the transistor as compared with a case of applying 0 V to the gate electrode. Consequently, holding properties of the memory 61 can be improved.

(Eighth Embodiment)

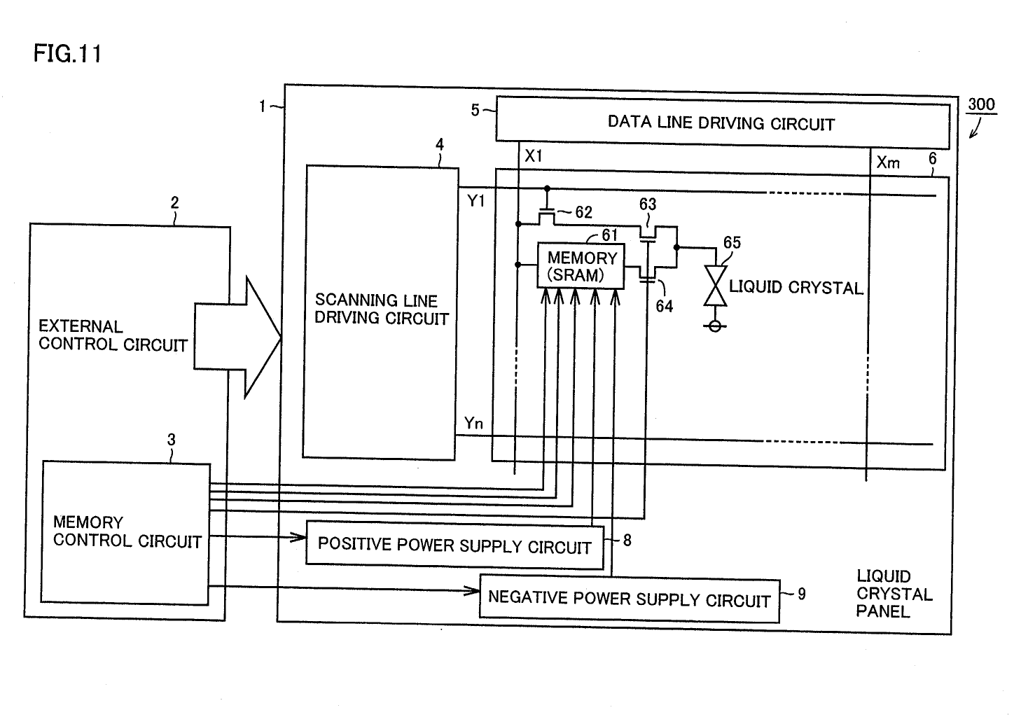

Referring to FIG. 11, both of a positive power supply circuit 8 and a negative power supply circuit 9 are built into a liquid crystal panel 1 in a liquid crystal display 300 according to an eight embodiment of the present invention.

The positive power supply circuit 8 according to the eighth embodiment may have a structure similar to that of the positive power supply circuit 8 according to any of the aforementioned first to sixth embodiments. The negative power supply circuit 9 may have a structure similar to that of the aforementioned negative power supply circuit 9 according to the seventh embodiment.

According to the eighth embodiment, both of the positive power supply circuit 8 and the negative power supply circuit 9 are built into the liquid crystal panel 1 as hereinabove described, whereby the positive power supply circuit 8 can operate a memory 61 and the negative power supply circuit 9 can improve data holding properties of the memory 61 in a wait state.

Although the present invention has been described and illustrated in detail, it is clearly understood that the same is by way of illustration and example only and is not to be taken by way of limitation, the spirit and scope of the present invention being limited only by the terms of the appended claims.

While each of the aforementioned embodiments has been described with reference to a display consisting of a liquid crystal display (LCD), for example, the present invention is not restricted to this but is also applicable to another display such as an EL display so far as the display includes a memory in a pixel part.

While the clock generation part 11 and the driver part 12 forming the negative power supply circuit 9 according the aforementioned seventh embodiment are absolutely similar in structure to those of the first embodiment, the present invention is not restricted to this but those similar to the clock generation part 11 and the driver part 12 according to any of the aforementioned fourth to sixth embodiments may be employed or the clock generation part 11 may be omitted similarly to the third embodiment. Further, the negative power supply circuit 9 according to each of the seventh and eighth embodiments may be provided with an output value holding circuit similar to the output value holding circuit 14 according to the second embodiment shown in FIG. 4.

What is claimed is:

1. A display comprising:
a pixel part having a memory; and
a power supply circuit formed on the same substrate as said pixel part for operating said memory,
said power supply circuit at least including:
a driver part for amplifying a clock signal, and
a pump part for performing charge pumping on the basis of said clock signal output from said driver part.

2. The display according to claim 1, wherein
said power supply circuit further includes a clock generation part for generating said clock signal.

3. The display according to claim 2, wherein
said clock generation part includes a ring oscillator.

4. The display according to claim 1, wherein
said power supply circuit further includes an output value holding circuit for holding an output value from said pump part.

5. The display according to claim 4, wherein
said output value holding circuit starts operation in response to complete writing of still picture video data in said memory.

6. The display according to claim 4, wherein
said power supply circuit further includes:
a first switch provided between said pump part and an output terminal of said power supply circuit to be turned off in response to complete writing of still picture video data in said memory, and
a second switch provided between said output value holding circuit and said output terminal of said power supply circuit to be turned on in response to said complete writing of said still picture video data in said memory.

7. The display according to claim 2, wherein
said power supply circuit further includes an output value holding circuit for holding an output value from said pump part, and
a current consumed by said output value holding circuit is smaller than a current consumed by said clock generation part, said driver part and said pump part.

8. The display according to claim 1, wherein
said power supply circuit consists of said driver part and said pump part, and
a basic clock signal operating with the same power
supply voltage as said pump part is input in said driver part.

9. The display according to claim 8, wherein
said pump part performs step-up operation by making a voltage reach a desired power supply voltage through said basic clock signal before entering a standby state.

10. The display according to claim 2, wherein
said clock generation part includes a voltage conversion circuit for converting a basic clock signal operating with a lower power supply voltage than said pump part to the same power supply voltage as said pump part.

11. The display according to claim 10, wherein
said pump performs step-up operation by making a voltage reach a desired power supply voltage through said basic clock signal and said voltage conversion circuit before entering a standby state.

12. The display according to claim 1, wherein
said clock generation part includes:
a clock generation circuit for generating said clock signal, and
a selection switch for selectively inputting said clock signal generated by said clock generation circuit and a basic clock signal in said driver part.

13. The display according to claim 12, wherein
said clock generation part includes a voltage conversion circuit for converting a basic clock signal operating with a lower power supply voltage than said pump part to the same power supply voltage as said pump part.

14. The display according to claim 1, including either a liquid crystal display or an organic EL display.

15. A display comprising:
a pixel part having a memory; and
a power supply circuit formed on the same substrate as said pixel part for operating said memory,
said power supply circuit at least including a negative power supply circuit.

16. The display according to claim 15, wherein
said power supply circuit includes both of said negative power supply circuit and a positive power supply circuit.

17. The display according to claim 15, wherein
said negative power supply circuit at least includes:
a driver part for amplifying a clock signal, and
a pump part for performing charge pumping on the basis of said clock signal output from said driver part.

18. The display according to claim 17, wherein
said negative power supply circuit further includes a clock generation part for generating said clock signal.

19. The display according to claim 15, including either a liquid crystal display or an organic EL display.
